(19) United States
(12) Patent Application Publication
(10) Pub. No.: US 2023/0041809 A1
(43) Pub. Date: Feb. 9, 2023

(54) TERMINAL AND COMMUNICATION METHOD

(71) Applicant: NTT DOCOMO, INC., Tokyo (JP)

(72) Inventors: Hiroki Harada, Chiyoda-ku, Tokyo (JP); Satoshi Nagata, Chiyoda-ku, Tokyo (JP); Lihui Wang, Haidian District, Beijing (CN)

(73) Assignee: NTT DOCOMO, INC., Tokyo (JP)

(21) Appl. No.: 17/758,325

(22) PCT Filed: Jan. 10, 2020
(86) PCT No.: PCT/JP2020/000769

§ 371 Date: Jul. 1, 2022

(51) Int. Cl. H04W 72/12; H04L 1/00; H04L 5/00

(52) U.S. Cl. CPC H04W 72/1263; H04L 1/0067; H04L 5/001

(57) ABSTRACT

A terminal includes a receiving unit that receives, through a first component carrier of a plurality of component carriers forming carrier aggregation, scheduling information for one or more second component carriers of the plurality of component carriers; and a control unit that configures rate matching on the one or more second component carriers, based on configuration information on the rate matching included in the scheduling information.

### TECHNICAL FIELD

The present invention relates to a terminal and a communication method in a radio communication system.

### BACKGROUND ART

New Radio (NR) Dynamic spectrum sharing (DSS) is a method of using Long Term Evolution (LTE) and NR in a same carrier. In the LTE system, Cell Specific Reference Signal (CRS), Physical Downlink Control Channel (PDCCH), or the like are transmitted for an LTE user. Accordingly, in DSS, PDCCH and data of NR are transmitted while avoiding a time resource for transmitting a signal for an LTE user.

For 3GPP Release 17, a DSS enhancement has been studied. As specific details of the DSS enhancement, for example, it has been studied to perform cross-carrier scheduling of Physical Downlink Shared Channel (PDSCH) or Physical Uplink Shared Channel (PUSCH) of a PCell (or Primary Secondary Cell (PSCell)) by Physical Downlink Control Channel (PDCCH) of a secondary cell (SCell) in CA. Furthermore, it has been studied, for a PDCCH of P(S)Cell/SCell, to perform scheduling of PDSCHs of a plurality of cells using a single Downlink Control Information (DCI).

### RELATED ART DOCUMENT

### Non-Patent Document

Non-Patent Document 1: 3GPP TSG RAN Meeting #86, RP-193260, Sitges, Spain, Dec. 9-12,
Non-Patent Document 2: 3GPP TS38.212 V15.7.0(2019-09)
Non-Patent Document 3: 3GPP TS38.214 V15.7.0(2019-09)

### SUMMARY OF THE INVENTION

### Problem to be Solved by the Invention

It has been studied to minimize a size of a single DCI used for scheduling of multiple cells. In contrast, by including a Rate matching indicator field in the DCI, it is possible to specify whether rate matching is applied to a scheduled cell and a type of a rate matching pattern to be applied.

In a case where multiple cells are to be scheduled by a single DCI, there is a need for a method of efficiently specifying whether rate matching is to be applied to the scheduled cells.

### Means for Solving the Problem

According to an aspect of the present invention, there is provided a terminal including a receiving unit that receives, through a first component carrier of a plurality of component carriers forming carrier aggregation, scheduling information for one or more second component carriers of the plurality of component carriers; and a control unit that configures rate matching on the one or more second component carriers, based on configuration information on rate matching included in the scheduling information.

### Advantage of the Invention

According to an embodiment, a method of efficiently specifying whether rate matching is applied to scheduled cells is provided in a case where multiple cells are scheduled by a single DCI.

### BRIEF DESCRIPTION OF DRAWINGS

FIG. 1 is a configuration diagram of a communication system according to embodiments.

FIG. 2 is a diagram illustrating an example of a scheduling of a plurality of cells by using a single DCI.

FIG. 3 is a diagram illustrating an example of a correspondence between a bit value of a Rate matching indicator field and on/off of each rate matching pattern.

FIG. 4 is a diagram illustrating an example of joint coding between a Rate matching indicator field and a BWP indication field.

FIG. 5 is a diagram illustrating an example of a functional configuration of a terminal.

FIG. 6 is a diagram illustrating an example of a functional configuration of a base station.

FIG. 7 is a diagram illustrating an example of a hardware configuration of each of a terminal and a base station.

### EMBODIMENTS OF THE INVENTION

In the following, embodiments of the present invention are described with reference to the drawings. Note that the embodiments described below are merely examples, and embodiments to which the present invention is applied are not limited to the following embodiments.

A radio communication system in the following embodiments is assumed, basically, to conform to NR. However, this is an example, and a portion of the radio communication system or all the radio communication system according to the embodiments may conform to a radio communication system (e.g., LTE) other than NR.

(Overall System Configuration)

FIG. 1 illustrates a configuration diagram of a radio communication system according to an embodiment. The radio communication system according to the embodiment includes a terminal 10 and a base station 20, as illustrated in FIG. 1. In FIG. 1, one terminal 10 and one base station 20 are illustrated. However, this is an example, and there may be a plurality of terminals 10 and a plurality of base stations 20.

The terminal 10 is a communication device provided with a radio communication function, such as a smartphone, a cellular phone, a tablet, a wearable terminal, and a communication module for Machine-to-Machine (M2M). The terminal 10 utilizes various communication services provided by a radio communication system by receiving a control signal or data in DL from the base station 20 and transmitting a control signal or data in UL to the base station 20. For example, channels transmitted from terminal 10 include Physical Uplink Control Channel (PUCCH) and Physical Uplink Shared Channel (PUSCH). Furthermore, the terminal 10 may be referred to as a UE, and the base station 20 may be referred to as a gNB.

In the embodiments, a duplex method may be a Time Division Duplex (TDD) method or a Frequency Division Duplex (FDD) method.

In the embodiments, “configuring” a radio parameter or the like may imply that a predetermined value is pre-configured or the radio parameter or the like is configured based on a radio parameter notified by the base station 20 or the terminal 10.

The base station 20 is a communication device that provides one or more cells and performs radio communication with the terminal 10. Physical resources of a radio signal may be defined in a time domain and a frequency domain, the time domain may be defined in OFDM symbols, and the frequency domain may be defined in a number of one or more subcarriers or a number of one or more resource blocks. The base station 20 transmits a synchronization signal and system information to the terminal 10. A synchronization signal is, for example, NR-PSS and NR-SSS. A part of system information is transmitted, for example, on NR-PBCH and is also called broadcast information. The synchronization signal and broadcast information may be periodically transmitted as an SS block (SS/PBCH block) including a predetermined number of OFDM symbols. For example, the base station 20 transmits a control signal or data to the terminal 10 in Downlink (DL) and receives a control signal or data in Uplink (UL) from the terminal 10. The base station 20 and the terminal 10 are capable of beam forming to transmit and receive signals. For example, as illustrated in FIG. 1, a reference signal transmitted from the base station 20 includes a Channel State Information Reference Signal (CSI-RS) and a channel transmitted from the base station 20 includes a Physical Downlink Control Channel (PDCCH) and a Physical Downlink Shared Channel (PDSCH).

(NR Dynamic Spectrum Sharing (DSS))

New Radio (NR) Dynamic spectrum sharing (DSS) is a method of using Long Term Evolution (LTE) and NR in the same carrier. In LTE system, Cell Specific Reference Signal (CRS), Physical Downlink Control Channel (PDCCH), and the like are transmitted for an LTE user. Accordingly, in DSS, PDCCH and data of NR are transmitted while avoiding a time resource for transmitting a signal to an LTE user.

For DSS, methods have been introduced so far, such as a method of introducing signaling for rate matching an LTE CRS resource, and a method of shifting a location of an NR DMRS so as to avoid a collision between the NR Demodulation Reference Signal (DMRS) and an LTE CRS.

Since a carrier to which DSS is applied is a carrier used in the LTE system, the carrier is on a lower frequency, such as 800 MHz and 2 GHz, compared to a normal NR carrier. As described above, since a carrier to which DSS is applied is the carrier used in the LTE system, at the NR system side, an NR control signal is mapped onto a carrier while avoiding a control signal, CRS, or the like of LTE. Accordingly, for a carrier to which DSS is applied, it is assumed that capacity for transmitting NR control signals is reduced compared to capacity for transmitting NR control signals in a normal NR carrier.

Here, it is assumed that a carrier aggregation (CA) including a carrier to which DSS is applied is performed in the NR system. As described above, a carrier to which DSS is applied is a carrier on a lower frequency compared to a normal NR carrier. Accordingly, it is assumed that carrier aggregation (CA) is performed while using a carrier to which DSS is applied as a primary cell (PCell). However, as described above, it is expected that, for a carrier to which DSS is applied, capacity for transmitting NR control signals is reduced compared to capacity for transmitting NR control signals in a normal NR carrier. Accordingly, in this case, the capacity for transmitting the NR control signals of the carrier to which DSS is applied may be insufficient as that of a PCell.

Accordingly, in 3GPP Release 17, enhancement of DSS has been studied. A frequency range (FR) may be assumed to be limited to FR1 of the combination of Frequency Range (FR) 1 and FR2, for example.

As specific details of the DSS enhancement, for example, it has been studied to perform cross-carrier scheduling of a Physical Downlink Shared Channel (PDSCH) or a Physical Uplink Shared Channel (PUSCH) of a PCell (or primary second cell (PSCell)) by a Physical Downlink Control Channel (PDCCH) of a secondary cell (SCell) in CA. Furthermore, for PDCCH of a P(S)Cell/SCell, it has been studied to perform scheduling of PDSCHs of a plurality of cells using single Downlink Control Information (DCI). A number of cells for scheduling using a single DCI may be, for example, two, or greater than two.

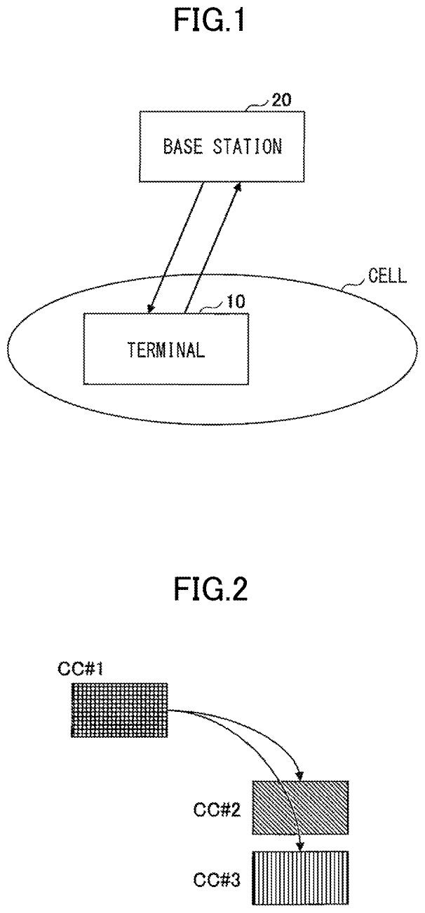

It has been studied to minimize the size of a single DCI used for scheduling of PDSCHs in a plurality of cells. For example, an upper limit may be defined on the size of the single DCI used for scheduling of PDSCHs in the plurality of cells. Although the above-described example assumes scheduling of PDSCHs in a plurality of cells by the single DCI, the number of DCIs is not limited to this example, and the number of DCIs may be greater than or equal to two, for example. Furthermore, scheduling of a plurality of cells may be, for example, when CA including component carriers (CC) #1, CC #2, and CC #3 is performed, as illustrated in FIG. 2, to perform scheduling of PUSCH transmission and/or PDSCH reception in the terminal 10 through the CC #2, and/or to perform scheduling of PUSCH transmission and/or PDSCH reception in the terminal 10 through the CC #3 by the DCI transmitted from the base station 20 to the terminal 10 through the CC #1. In the example of FIG. 2, three component carriers are illustrated, but the number of component carriers is not limited to three. For example, a number of component carriers may be 2, or a number of component carriers may be greater than 3. Furthermore, the cell performing scheduling (CC #1 in the example of FIG. 2) may be one of multiple cells to be scheduled.

(DCI Format 1_1)

DCI is transmitted through PDCCH. A DCI format 1_1 can be used to perform downlink scheduling (Downlink scheduling assignment) or uplink scheduling (uplink grant) of the terminal 10. The DCI format 1_1 may include, for example, an identifier of the DCI format, resource information, information related to a transport block, information related to Hybrid Automatic Repeat Request (HARQ), information related to multiple antennas, information related to Physical Uplink Control Channel (PUCCH), or the like.

For example, the DCI format 1_1 may include a Carrier indicator, a Bandwidth-part indicator, Frequency-domain resource allocation, Time-domain resource allocation, VRB-to-PRB mapping, PRB bundling size indicator, Rate matching indicator, Zero-power CSI-RS trigger, or the like, as resource information.

The inclusion of the Carrier Indicator field (CIF) in DCI format 1_1 indicates that cross-carrier scheduling is configured. A number of bits of the Carrier indicator included in the CIF is 0 bit or 3 bits and is used to indicate a component carrier related to DCI.

(Rate Matching Indicator Field)

In the following, an overview of the Rate matching indicator field is described. The rate matching indicator field may be, for example, information indicating whether the rate matching pattern configured for a plurality of resource elements (REs) can be used for PDSCH, i.e., whether the rate matching is applied in a cell scheduled by DCI. As described above, the DCI format 1_1 includes the Rate matching indicator field. The size of the rate matching indicator field may be, for example, 0, 1, or 2 bits, depending on whether rateMatchPatternGroup1 and/or rateMatchPatternGroup2 is configured for multiple resource elements (REs) that can be used for downlink transmission.

For example, if rateMatchPatternGroup1 and rateMatchPatternGroup2 are configured for multiple REs that can be used to transmit downlinks, the size of the Rate matching indicator field may be 2 bits. Furthermore, for example, if only one of ratchMatchPatternGroup1 or rateMatchPatternGroup2 is configured for a plurality of REs that can be used for downlink transmission, the size of the Rate matching indicator field may be 1 bit. Furthermore, for example, if neither ratchMatchPatternGroup1 nor rateMatchPatternGroup2 is configured for multiple REs that can be used for downlink transmission, the size of the Rate matching indicator field may be 0 bit.

For example, if, for multiple REs, rateMatchPatternGroup1 and rateMatchPatternGroup2 are configured and the size of the Rate matching indicator field is 2 bits, one bit of the Rate matching indicator field may indicate whether the multiple REs for which ratchMatchPatternGroup1 is configured can be used for PDSCH, and the other bit of the Rate matching indicator field may indicate whether the multiple REs for which rateMatchPatternGroup2 is configured can be used for PDSCH. For example, when the above-described one bit of the Rate matching indicator field is 1, it may be indicated that the multiple REs to which the rateMatchPatternGroup1 is configured are unable to be used for PDSCH, i.e., rate matching based on the rateMatchPatternGroup1 is applied. Similarly, when the other bit of the Rate matching indicator field is 1, it indicates that the multiple REs to which the rateMatchPatternGroup2 is configured are unable to be used for PDSCH, i.e., rate matching based on the rateMatchPatternGroup2 is applied.

For example, during scheduling, while performing downlink scheduling, the base station 20 can specify whether rate matching is applied in a scheduled cell specified by the Rate matching indicator field.

In the following, a specific configuration of the rate matching indicator field is considered for a case in which a plurality of cells is scheduled. For example, it may be determined, for a plurality of cells scheduled by the base station 20, whether it can be specified to apply rate matching by the Rate matching indicator field, and how to specify the rate matching by the Rate matching indicator field. Additionally or alternatively, it may be determined, for one cell of a plurality of cells scheduled by the base station 20, whether it can be specified to apply rate matching by the Rate matching indicator field, and how to specify the rate matching by the Rate matching indicator field. In the embodiments described below, the number of CCs scheduled by a single DCI is 2, but the number of CCs scheduled by a single DCI is not limited to 2. The number of CCs scheduled by a single DCI may be, for example, 1 or greater than 2.

(Proposal 1)

If the base station 20 schedules multiple cells, it may be possible to indicate rate matching for each scheduled cell. If the base station 20 schedules multiple cells, an indication of rate matching may be made by the Rate matching indicator field for each cell of the multiple cells. The terminal 10 may configure whether rate matching is applied based on a value set in the Rate matching indicator field.

(Proposal 1-1)

If the base station 20 schedules multiple cells with a single DCI, the rate matching indicator field may be extended to, for example, X bits. Here, X can be {0, 1, or 2}+{0, 1, or 2} based on whether rateMatchPatternGroup1 and/or RateMatchPatternGroup2 is configured in each scheduled cell. That is, X may be, for example, the sum of the number of bits necessary to specify rateMatchPatternGroup1 and/or RateMatchPatternGroup2 to be configured in each cell of the multiple cells. Note that X may be determined based on the number of cells to be scheduled. Note that rateMatchPatternGroup may be a set of resource elements that are unable to be used for PDSCH when rate matching is applied.

For example, in the example illustrated in FIG. 2, suppose that PDCCH transmissions on CC #2 and CC #3 are scheduled for the terminal 10 by the DCI transmitted from the base station 20 via the PDCCH of CC #1. Furthermore, suppose that, for example, only the ratchMatchPatternGroup1 is configured for CC #2 and rateMatchPatternGroup1 and RateMatchPatternGroup2 are configured for CC #3. In this case, the Rate Matching Indicator field in DCI may include a total of three bits, which are one bit indicating whether it is possible to use ratchMatchPatternGroup1 for PDSCH in CC #2, and two bits indicating whether it is possible to use ratchMatchPatternGroup1 for PDSCH and whether it is possible to use rateMatchPatternGroup2 for PDSCH in CC #3.

The terminal 10 that receives DCI via PDCCH of CC #1 may configure the rate matching on CC #2 based on a 1-bit value indicating whether rateMatchMatchPatternGroup1 can be used for PDSCH in CC #2 included in the Rate matching indicator field included in the DCI and may configure rate matching on CC #3 based on a 2-bit value indicating whether rateMatchPatternGroup1 can be used for PDSCH and rateMatchPatternGroup2 can be used for PDCCH in CC #3 included in the Rate matching indicator field.

(Proposal 1-2)

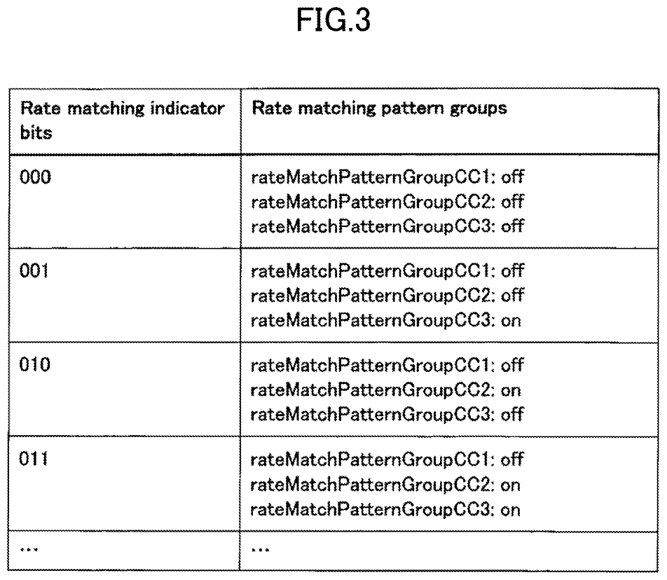

If the base station 20 schedules multiple cells with a single DCI, the Rate matching indicator field may be extended to, for example, Y bits. The value of Y may be, for example, the number of rate matching pattern groups that are preconfigured or the number of rate matching pattern groups that are configured by RRC signaling. For example, as illustrated in FIG. 3, suppose that rateMatchPatternGroupCC1, ratchMatchPatternGroupCC2, and rateMatchPatternGroupCC3 are preconfigured. Here, rateMatchPatternGroupCC1, ratchMatchPatternGroupCC2, and rateMatchPatternGroupCC3 may be patterns (e.g., bitmaps) that specify a set of multiple REs of one or more cells to be scheduled, respectively. Alternatively, each of the ratchMatchPatternGroupCC1, ratchMatchPatternGroupCC2, and ratchMatchPatternGroupCC3 may include one or more of the rateMatchPattern or rateMatchPatternGroup configured for each cell to be scheduled (e.g., rateMatchPatternGroupCC1 includes only the rateMatchPatternGroup1 configured for CC #2, rateMatchPatternGroupCC2 includes the rateMatchPatternGroup1 configured for CC #2 and ratchMatchPatternGroup1 and rateMatchPatternGroup2 configured for CC #3, and rateMatchPatternGroupCC3 includes rateMatchPatternGroup1 and rateMatchPatternGroup2 configured for CC #3). If three rate matching pattern groups are preconfigured, as in the example of FIG. 3, the value of Y may be 3, for example. In the example of FIG. 3, for example, the first Most Significant Bit (MSB) out of the three bits of the Rate matching indicator field may indicate whether it is possible to use ratchMatchPatternGroupCC1 for PDSCH. In the example of FIG. 3, for example, the second MSB out of the three bits of the Rate matching indicator field may indicate whether rateMatchMatchPatternGroupCC2 can be used for PDSCH. In the example of FIG. 3, for example, among the three bits of the Rate matching indicator field, the least significant bit (LSB) may indicate whether it is possible to use ratchMatchPatternGroupCC3 for PDSCH. For example, as illustrated in FIG. 3, when the base station 20 sets a value “011” in the Rate matching indicator field and transmits the value to the terminal 10, the terminal 10 may determine (assume) that it is possible to use the ratchMatchPatternGroupCC1 for the PDSCH, that it is not possible to use the ratchMatchPatternGroupCC2 for the PDSCH, and that it is not possible to use the rate MatchPatternGroupCC3 for the PDSCH. In the example of FIG. 3, the value of Y is 3, but the value of Y is not limited to 3. The value of Y may be less than or equal to 2 or greater than 3.

(Proposal 1-3)

If the base station 20 schedules multiple cells with a single DCI, the size of the rate matching indicator field need not be extended. For example, the size of the Rate matching indicator field may be 0 bits (when none of the ratchMatchPatternGroup1 and RateMatchPatternGroup2 is configured), 1 bit (when only one of the ratchMatchPatternGroup1 or RateMatchPatternGroup2 is configured), or 2 bits (when rateMatchPatternGroup1 and rateMatchPatternGroup2 are configured), depending on whether rateMatchPatternGroup1 and/or RateMatchPatternGroup2 is configured. For example, if the first CC and the second CC are scheduled by a single DCI, mapping may be defined between the bit value set in the rate matching indicator field and a combination of the rate matching configurations in each CC, so that the combination of the rate matching configuration in the first CC and the rate matching configuration in the second CC is specified based on the bit value set in the rate matching indicator field. Such mapping may be predefined by a technical specification or may be configured by a higher layer, for example. In this case, the size of the Rate matching indicator field may be predetermined or configured by a higher layer, or the size of the Rate matching indicator field may be set to be the larger or the smaller of the size of the Rate matching indicator field for the first CC and the size of the Rate matching indicator field for the second CC.

(Proposal 2)

If the base station 20 schedules multiple cells by a single DCI, the rate matching may be configured by the rate matching indicator field for one of the cells (which may be one or more cells). The terminal 10 may configure the rate matching specified by the bit value of the rate matching indicator field for one of the multiple cells.

For example, in the example illustrated in FIG. 2, suppose that PDSCH transmissions on CC #2 and CC #3 are scheduled to the terminal 10 by the DCI transmitted from the base station 20 via the PDCCH of CC #1. In this case, for example, the rate matching on CC #2 may be configured by the bit value set to the rate matching indicator field of the DCI transmitted from the base station 20 via the PDCCH of CC #1. The terminal 10 may configure the rate matching on CC #2 based on the bit value set to the rate matching indicator field.

(Proposal 2-1)

If the base station 20 schedules multiple cells, the rate matching indicator field may be extended to, for example, X bits. Here, X may be {0, 1, 2, 3, or 4} based on the maximum number+(1 or 2) of the rate matching pattern groups in each cell to be scheduled.

For example, if X is the maximum number of rate matching pattern groups in each cell to be scheduled+1, one bit of Rate matching indicator field (e.g., 1 Most Significant Bit (MSB) or 1 Least Significant Bit (LSB)) may specify one cell for the terminal 10 for which a rate matching pattern is specified. In this case, the terminal 10 may determine (assume) that no rate matching pattern is specified for the other cells among the multiple cells.

For example, if X is the maximum of the number of rate matching pattern groups in each cell to be scheduled+2, two bits of the rate matching indicator field (e.g., 2 MSBs or 2 LSBs) may specify a cell for the terminal 10 for which the rate matching pattern is specified.

(Proposal 2-2)

If the base station 20 schedules multiple cells with a single DCI, the size of the rate matching indicator field need not be extended. For example, the size of the Rate matching indicator field may be 0, 1, or 2 bits. For example, the size of the Rate matching indicator field may be either 0, 1, or 2 bits based on the configuration of ratchMatchPatternGroup1 and/or RateMatchPatternGroup2 for a particular cell to be scheduled. In this example, it is assumed that rateMatchPatternGroup1 and/or RateMatchPatternGroup2 is configured for the particular cell. However, the embodiments are not limited to this example. For example, the number of rateMatchPatternGroups configured for a particular cell may be three or more.

(Proposal 2-2-1)

In Proposal 2-2 above, the particular cell to be scheduled may be configured, for example, based on the cell index. For example, the particular cell to be scheduled may be a cell having the smallest serving cell index, from among the multiple cells to be scheduled.

(Proposal 2-2-2)

In Proposal 2-2 above, the particular cell to be scheduled may be the cell having the largest number of rate match pattern groups, from among the multiple cells to be scheduled.

(Proposal 2-2-3)

In Proposal 2-2 above, the particular cell to be scheduled may be determined by RRC configuration.

In the above-described Proposal 2-2-1 to Proposal 2-2-3, among the multiple cells to be scheduled, the terminal 10 may determine (assume) that the rate matching pattern is not specified for a cell other than the particular cell. The particular cell may also be determined by any combination of Proposal 2-2-1 to Proposal 2-2-3.

(Proposal 2′)

If the base station 20 schedules multiple cells by a single DCI, if one of the multiple cells to be scheduled is the cell performing scheduling (i.e., if the cell performing scheduling schedules the own cell and the other cell by the single DCI) it may be possible to configure the rate matching for the cell performing scheduling by the rate matching indicator field. However, configuring the rate matching by the rate matching indicator field for a cell other than the cell performing scheduling, from among the multiple cells to be scheduled, may be disallowed.

(Proposal 3)

If the base station 20 schedules multiple cells with a single DCI, the rate matching need not be configured for the multiple cells.

(Proposal 3-1)

For example, if the base station 20 schedules multiple cells, the terminal 10 may determine (expect) that the size of the rate matching indicator field is zero. In this case, the terminal 10 may expect that the rate matching is not configured for each cell of the multiple cells to be scheduled.

(Proposal 3-2)

In the case of Proposal 3 described above, the terminal 10 may expect that the size of the Rate matching indicator field is 0, 1, or 2 bits. In this case, the terminal 10 may ignore the Rate matching indicator field and expect that the rate matching is not configured for each cell from among multiple cells to be scheduled. For example, if the base station 20 schedules multiple cells, the terminal 10 may expect that all bits of the Rate matching indicator field are set to zero.

(Proposal 4)

If the base station 20 schedules multiple cells by a single DCI, it may be possible to configure, by RRC signaling, whether the terminal 10 is expected to configure the rate matching based on the Rate matching indicator field. For example, by RRC signaling, any of the above-described methods of Proposal 1 to Proposal 3 may be configured for the terminal 10.

(Proposal 5)

If the base station 20 schedules multiple cells by a single DCI, if one or more of the following conditions 1 and 2 are satisfied, the base station 20 may be able to configure the rate matching based on the Rate matching indicator field for the terminal 10.

(Condition 1) In the multiple cells to be scheduled, the number of rate matching pattern groups is the same.

(Condition 2) It is possible to simultaneously perform rate matching configured by the same rate matching pattern group identifier for the multiple cells to be scheduled.

(Proposal 6)

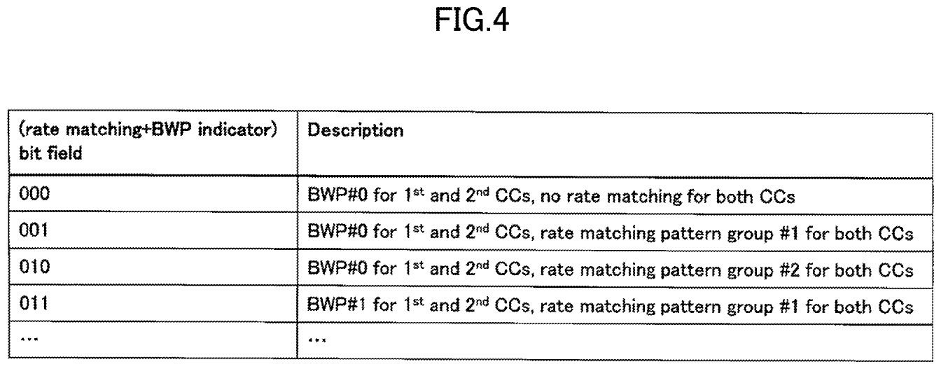

If the base station 20 schedules multiple cells with a single DCI, joint coding of the rate matching indicator field with another field may be performed. For example, joint coding of the Rate matching indicator field and the BWP indicator field may be performed as illustrated in FIG. 4. For example, as illustrated in FIG. 4, the association between (rate matching+BWP indicator) bit field and the configurations of BWP and rate matching on the specified component carrier may be defined. In this case, for example, the base station 20 may transmit the (Rate matching+BWP indicator) bits to the terminal 10 by including the (Rate matching+BWP indicator) bit field in the DCI, and the terminal 10 that receives the (Rate matching+BWP indicator) bits may activate the specified BWP on the specified component carrier and may configure the rate matching on the specified component carrier, based on the association illustrated in FIG. 4. In the example illustrated in FIG. 4, the joint coding of the rate matching indicator field and the BWP indicator field is illustrated. However, the embodiments are not limited to this example. For example, joint coding between the Rate matching indicator field and Carrier Indicator Field (CIF) may be performed. Alternatively, joint coding with the rate matching indicator field, CIF, and BWP indicator field may be performed.

The above-described Proposal 1 to Proposal 6 may be applied to the ZP-CSI-RS trigger field in DCI format 1_1. For example, in the example illustrated in FIG. 2, suppose that the PDSCH transmissions on CC #2 and CC #3 are scheduled to the terminal 10 by the DCI transmitted from the base station 20 via the PDCCH on CC #1. Furthermore, suppose that only one ZP-CSI-RS-ResourceSet is configured for CC #2 and two aperiodic ZP-CSI-RS-ResourceSets are configured for CC #3. In this case, the ZP-CSI-RS trigger field of the DCI may include a total of three bits, which are one bit indicating whether aperiodic ZP-CSI-RS is configured for CC #2 and two bits indicating whether aperiodic ZP-CSI-RSs are configured for CC #3. The terminal 10 receiving the DCI via PDCCH of CC #1 may receive aperiodic ZP-CSI-RS on CC #2 based on the value of the 1 bit indicating whether the aperiodic ZP-CSI-RS is configured for CC #2 included in the ZP-CSI-RS trigger field, and may receive aperiodic ZP-CSI-RSs on CC #3 based on the value of the 2 bits indicating whether the aperiodic ZP-CSI-RSs are configured for CC #3 included in the ZP-CSI-RS trigger field. For example, the rate matching indicator field in Proposal 1-2, 1-3, and 2-1 may be replaced with the ZP-CSI-RS trigger field.

(Device Configuration)

Next, an example of a functional configuration of the terminal 10 and the base station 20 that execute the processing operation described above is described. Each of the terminal 10 and the base station 20 is provided with all of the functions described in the embodiments. However, each of the terminal 10 and the base station 20 may include only a part of the functions described in the embodiments. The terminal 10 and the base station 20 may be collectively referred to as a communication device.

<Terminal>

FIG. 5 is a diagram illustrating an example of a functional configuration of the terminal 10. As illustrated in FIG. 5, the terminal 10 includes a transmitting unit 110, a receiving unit 120, and a control unit 130. The functional configuration illustrated in FIG. 5 is merely one example. If the operation according to the present embodiment can be executed, functional divisions and names of functional units may be any divisions and names. Here, the transmitting unit 110 may be referred to as a transmitter and the receiving unit 120 may be referred to as a receiver.

The transmitting unit 110 creates a transmission from the transmission data and transmits the transmission signal through radio. The transmitting unit 110 is capable of forming one or more beams. The receiving unit 120 receives various types of signals through radio and obtains a higher layer signal from the received physical layer signal. The receiving unit 120 includes a measuring unit that measures a received signal and obtains received power, etc.

The control unit 130 controls the terminal 10. The function of the control unit 130 related to transmission may be included in the transmitting unit 110, and the function of the control unit 130 related to reception may be included in the receiving unit 120.

For example, the receiving unit 120 receives DCI including scheduling information from the base station 20 through PDCCH. The control unit 130 configures rate matching on each component carrier based on a value set in the Rate matching indicator field included in the DCI.

<Base Station 20>

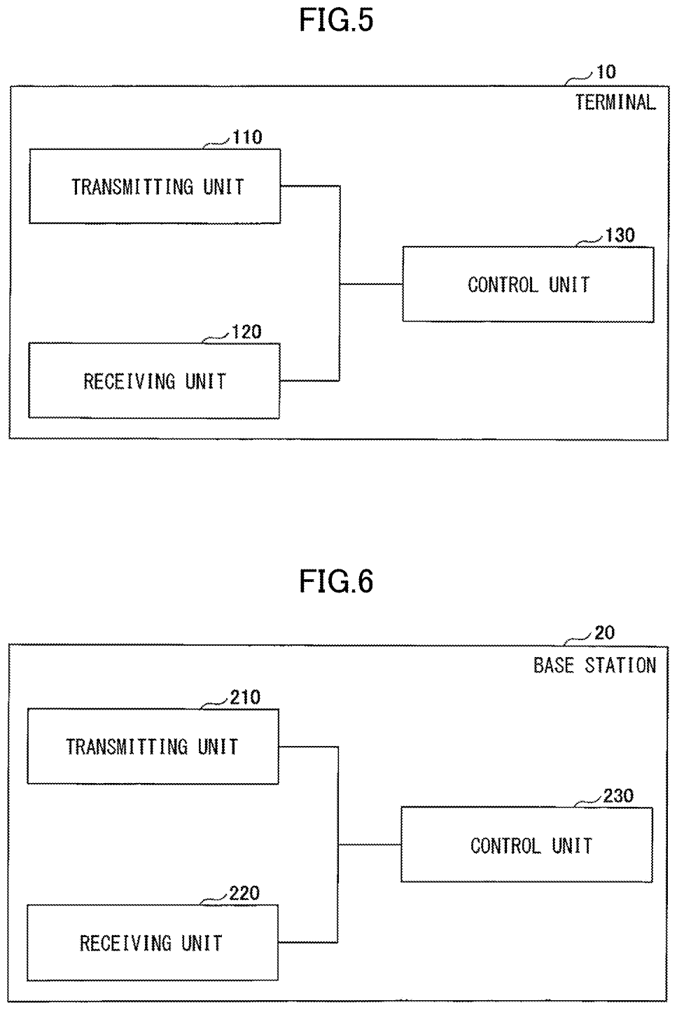

FIG. 6 is a diagram illustrating an example of a functional configuration of the base station 20. As illustrated in FIG. 6, the base station 20 includes a transmitting unit 210, a receiving unit 220, and a control unit 230. The functional configuration illustrated in FIG. 6 is only one example. The function division and the names of the functional units may be any division and names, provided that the operation according to the embodiments can be executed. The transmitting unit 210 may be referred to as a transmitter, and the receiving unit 220 may be referred to as a receiver.

The transmitting unit 210 includes a function for generating a signal to be transmitted to the terminal 10 and transmitting the signal through radio. The receiving unit 220 includes a function for receiving various signals transmitted from the terminal 10 and obtaining, for example, information of a higher layer from the received signals. The receiving unit 220 includes a measuring unit that measures a received signal and obtains received power.

The control unit 230 controls the base station 20. The function of the control unit 230 related to transmission may be included in the transmitting unit 210, and the function of the control unit 230 related to reception may be included in the receiving unit 220.

For example, when a plurality of cells is to be scheduled, the control unit 230 generates a Rate matching indicator field including configuration information for rate matching on each component carrier and includes the Rate matching indicator field in the DCI including the scheduling information. The transmitting unit 210 transmits the DCI generated by the control unit 230 through PDCCH.

<Hardware Configuration>

The block diagrams (FIG. 5 to FIG. 6) used in the description of the above-described embodiments illustrate blocks in units of functions. These functional blocks (components) are implemented by any combination of hardware and/or software. Furthermore, the means for implementing each functional block is not particularly limited. That is, each functional block may be implemented by one device with a physical and/or logical combination of elements, or may be implemented by two or more devices while directly and/or indirectly (e.g., wired and/or wireless) connecting the two or more devices that are physically and/or logically separated.

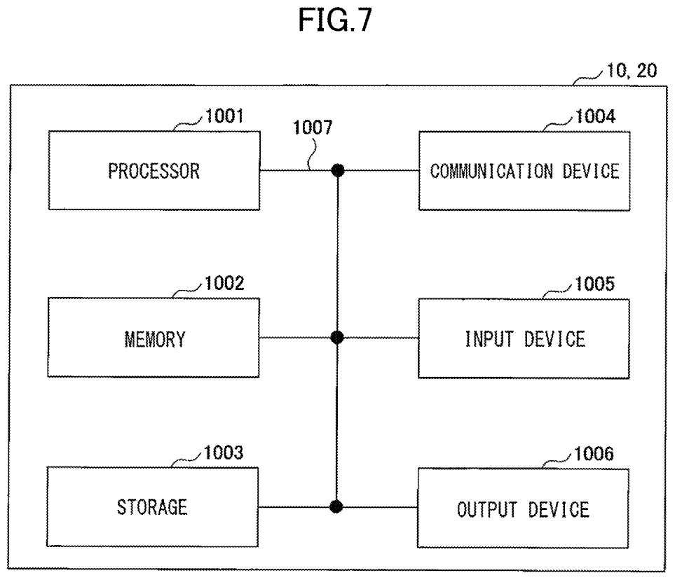

For example, each of the terminal 10 and the base station 20 according to one embodiment of the present invention may function as a computer performing the process according to this embodiments. FIG. 7 is a diagram illustrating an example of a hardware configuration of a terminal 10 and a base station 20 according to the embodiment. Each of the above-described terminal 10 and base station 20 may be physically configured as a computer device including a processor 1001, a memory 1002, a storage 1003, a communication device 1004, an input device 1005, an output device 1006, a bus 1007, or the like.

In the following description, the term “device” can be replaced with a circuit, a device, a unit, or the like. The hardware configuration of the terminal 10 and base station 20 may be configured to include one or more of the devices denoted by 1001-1006 in the figure, or may be configured without some devices.

Each function of the terminal 10 and the base station 20 is implemented by loading predetermined software (program) on hardware, such as the processor 1001 and the memory 1002, so that the processor 1001 performs computation and controls communication by the communication device 1004, and reading and/or writing of data in the memory 1002 and the storage 1003.

The processor 1001, for example, operates an operating system to control the entire computer. The processor 1001 may be configured with a central processing unit (CPU: Central Processing Unit) including an interface with a peripheral device, a control device, a processing device, a register, or the like.

Additionally, the processor 1001 reads a program (program code), a software module or data from the storage 1003 and/or the communication device 1004 to the memory 1002, and executes various processes according to these. As the program, a program is used which causes a computer to execute at least a part of the operations described in the above-described embodiment. For example, the transmitting unit 110, the receiving unit 120, and the control unit 130 of the terminal 10 illustrated in FIG. 5 may be implemented by a control program that is stored in the memory 1002 and operated by the processor 1001. For example, the transmitting unit 210, the receiving unit 220, and the control unit 230 of the base station 20 illustrated in FIG. 6 may be implemented by a control program stored in the memory 1002 and operated by the processor 1001. While the various processes described above are described as being executed in one processor 1001, they may be executed simultaneously or sequentially by two or more processors 1001. Processor 1001 may be implemented by one or more chips. The program may be transmitted from the network via a telecommunications line.

The memory 1002 is a computer readable storage medium, and, for example, the memory 1002 may be formed of at least one of a Read Only Memory (ROM), an Erasable Programmable ROM (EPROM), an Electrically Erasable Programmable ROM (EEPROM), a Random Access Memory (RAM). The memory 1002 may be referred to as a register, a cache, a main memory (main storage device), or the like. The memory 1002 may store a program (program code), a software module, or the like, which can be executed for implementing the process according to one embodiment of the present invention.

The storage 1003 is a computer readable storage medium and may be formed of, for example, at least one of an optical disk, such as a Compact Disc ROM (CD-ROM), a hard disk drive, a flexible disk, an optical magnetic disk (e.g., a compact disk, a digital versatile disk, a Blu-ray (registered trademark) disk), a smart card, a flash memory (e.g., a card, a stick, a key drive), a floppy (registered trademark) disk, a magnetic strip, or the like. The storage 1003 may be referred to as an auxiliary storage device. The above-described storage medium may be, for example, a database including memory 1002 and/or storage 1003, a server, or any other suitable medium.

The communication device 1004 is hardware (transmitting and receiving device) for performing communication between computers through a wired and/or wireless network, and is also referred to, for example, as a network device, a network controller, a network card, a communication module, or the like. For example, the transmitting unit 110 and the receiving unit 120 of the terminal 10 may be implemented by the communication device 1004. The transmitting unit 210 and the receiving unit 220 of the base station 20 may be implemented by the communication device 1004.

The input device 1005 is an input device (e.g., a keyboard, a mouse, a microphone, a switch, a button, or a sensor) that receives an external input. The output device 1006 is an output device (e.g., a display, speaker, or LED lamp) that performs output toward outside. The input device 1005 and the output device 1006 may be configured to be integrated (e.g., a touch panel).

Each device, such as processor 1001 and memory 1002, is also connected by the bus 1007 for communicating information. The bus 1007 may be formed of a single bus or may be formed of buses that differ among devices.

The terminal 10 and the base station 20 may each include hardware, such as a microprocessor, a digital signal processor (DSP), an Application Specific Integrated Circuit (ASIC), a Programmable Logic Device (PLD), and a Field Programmable Gate Array (FPGA), which may implement some or all of each functional block. For example, processor 1001 may be implemented by at least one of these hardware components.

### CONCLUSION OF THE EMBODIMENTS

In this specification at least the following terminal and communication method are disclosed.

A terminal including a receiving unit that receives, through a first component carrier of a plurality of component carriers forming carrier aggregation, scheduling information for one or more second component carriers of the plurality of component carriers; and a control unit that configures rate matching on the one or more second component carriers, based on configuration information on the rate matching included in the scheduling information.

According to the above-described configuration, the terminal can configure the rate matching in the scheduled component carrier based on the configuration information on the rate matching included in the scheduling information.

The configuration information on the rate matching may include information indicating whether one or more rate matching patterns configured for each component carrier of the one or more second component carriers can be used for a physical downlink shared channel (PDSCH).

According to the above configuration, the terminal can configure the rate matching in each component carrier based on the configuration information on the rate matching included in the scheduling information.

The second component carriers may consist of two component carriers, the configuration information on the rate matching may include information indicating whether a plurality of resource elements indicated by one or more rate matching patterns configured for one component carrier of the two component carriers can be used for a physical downlink shared channel of the one component carrier and information indicating whether a plurality of resource elements indicated by one or more rate matching patterns configured for the other component carrier of the two component carriers can be used for a PDSCH of the other component carrier.

According to the above configuration, the terminal can configure the rate matching in each component carrier based on the configuration information on the rate matching included in the scheduling information.

The one or more second component carriers may include the first component carrier, and the control unit may configure rate matching only for the first component carrier based on the configuration information on the rate matching included in the scheduling information.

According to the above configuration, when carrier aggregation is performed, for example, it is possible to perform operation such that the rate matching is performed only for the secondary cell.

A communication method by a terminal, the method including receiving, through a first component carrier of a plurality of component carriers forming carrier aggregation, scheduling information for one or more second component carriers of the plurality of component carriers; and configuring rate matching on the one or more second component carriers, based on configuration information on the rate matching included in the scheduling information.

According to the above-described configuration, the terminal can configure the rate matching in the scheduled component carrier based on the configuration information on the rate matching included in the scheduling information.

### SUPPLEMENTAL EMBODIMENTS

While the embodiments of the present invention are described above, the disclosed invention is not limited to the embodiments, and those skilled in the art will appreciate various alterations, modifications, alternatives, substitutions, or the like. Descriptions are provided using specific numerical examples to facilitate understanding of the invention, but, unless as otherwise specified, these values are merely examples and any suitable value may be used. Classification of the items in the above descriptions is not essential to the present invention, and the items described in two or more items may be used in combination as needed, or the items described in one item may be applied (provided that there is no contradiction) to the items described in another item. The boundaries of functional units or processing units in the functional block diagram do not necessarily correspond to the boundaries of physical components. An operation by a plurality of functional units may be physically performed by one component or an operation by one functional unit may be physically executed by a plurality of components. For the processing procedures described in the embodiments, the order of processing may be changed, provided that there is no contradiction. For the convenience of the description of the process, the terminal 10 and the base station 20 are described using functional block diagrams, but such devices may be implemented in hardware, software, or a combination thereof. Software operated by a processor in accordance with embodiments of the present invention and software operated by a processor in accordance with embodiments of the present invention may be stored in a random access memory (RAM), a flash memory (RAM), a read-only memory (ROM), an EPROM, an EEPROM, a register, a hard disk (HDD), a removable disk, a CD-ROM, a database, a server, or any other suitable storage medium, respectively.

Notification of information is not limited to the aspects/embodiments described in this specification, and notification of information may be made by another method. For example, notification of information may be implemented by physical layer signaling (e.g., Downlink Control Information (DCI), or Uplink Control Information (UCI)), higher layer signaling (e.g., Radio Resource Control (RRC) signaling, Medium Access Control (MAC) signaling, broadcast information (Master Information Block (MIB), System Information Block (SIB)), or other signals or combinations thereof. RRC signaling may be referred to as an RRC message, for example, which may be an RRC connection setup message, an RRC connection reconfiguration (RRC Connection Reconfiguration) message, or the like.

The aspects/embodiments described in this specification may be applied to a system using Long Term Evolution (LTE), LTE-Advanced (LTE-A), SUPER 3G, IMT-Advanced, 4G, 5G, Future Radio Access (FRA), W-CDMA (Registered Trademark), GSM (Registered Trademark), CDMA2000, Ultra Mobile Broadband (UMB), IEEE 802.11 (Wi-Fi), IEEE 802.16 (WiMAX), IEEE 802.20, Ultra-WideBand (UWB), Bluetooth (Registered Trademark), or any other appropriate system, and/or a next generation system extended based on theses.

The processing procedures, sequences, flow charts, or the like of each aspect/embodiment described herein may be reordered, provided that there is no contradiction. For example, the methods described in this specification present elements of various steps in an exemplary order and are not limited to the particular order presented.

The particular operation described in this specification to be performed by base station 20 may be performed by an upper node in some cases. It is apparent that in a network consisting of one or more network nodes having base stations 20, various operations performed for communicating with terminal 10 may be performed by base stations 20 and/or other network nodes other than base stations 20 (e.g., MME or S-GW can be considered, however, the network node is not limited to these). The case is exemplified above in which there is one network node other than the base station 20. However, the network node other than the base station 20 may be a combination of multiple other network nodes (e.g., MME and S-GW).

The aspects/embodiments described in this specification may be used alone, may be used in combination, or may be switched during execution.

The terminal 10 may be referred to by one of ordinary skill in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

The base station 20 may be referred to by one of ordinary skill in the art as NodeB (NB), enhanced NodeB (eNB), base station, gNB, or some other suitable terms.

A bandwidth part (BWP: Bandwidth Part) (which may also be referred to as a partial bandwidth) may represent, in a certain carrier, a subset of consecutive common RB (common resource blocks) for a certain numerology. Here, the common RB may be specified by an index of an RB when a common reference point of the carrier is used as a reference. A PRB may be defined in a BWP, and may be numbered in the BWP.

The BWP may include a BWP for UL (UL BWP) and a BWP for DL (DL BWP). For a UE, one or more BWPs may be configured within one carrier.

At least one of the configured BWPs may be active, and the UE does not expect that a predetermined signal/channel is communicated outside the active BWP. Note that “cell,” “carrier,” or the like in the present disclosure may be replaced with “BWP.”

The terms “determine (determining)” and “decide (determining)” used in this specification may include various types of operations. For example, “determining” and “deciding” may include deeming that a result of calculating, computing, processing, deriving, investigating, looking up (e.g., search in a table, a database, or another data structure), or ascertaining is determined or decided. Furthermore, “determining” and “deciding” may include, for example, deeming that a result of receiving (e.g., reception of information), transmitting (e.g., transmission of information), input, output, or accessing (e.g., accessing data in memory) is determined or decided. Furthermore, “determining” and “deciding” may include deeming that a result of resolving, selecting, choosing, establishing, or comparing is determined or decided. Namely, “determining” and “deciding” may include deeming that some operation is determined or decided.

The phrase “based on” used in this specification does not imply “based solely on” unless otherwise specified. In other words, “based on” means both “based solely on” and “at least based on.”

As long as the terms, such as “include (include),” “including (including),” and variants thereof, are used in this specification or in the claims, these terms are intended to be inclusive, similar to the term “comprising.” Furthermore, it is intended that the term “or” as used in this specification or in the claims is not an exclusive OR.

Throughout the present disclosure, if an article is added by translation, such as “a,” “an,” and “the” in English, these articles may include a plurality of things unless as otherwise indicated by the context clearly.

The present invention is described in detail above. It is apparent to those skilled in the art that the present invention is not limited to the embodiments described in this specification. The present invention can be implemented as modifications and alterations without departing from the gist and scope of the present invention as defined by the claims. Accordingly, the descriptions in this specification is intended for illustrative purposes and does not have any restrictive meaning to the present invention.

### LIST OF REFERENCE SYMBOLS

10 terminal
110 transmitting unit
120 receiving unit
130 control unit
20 base station
210 transmitting unit
220 receiving unit
230 control unit
1001 processor
1002 memory
1003 storage
1004 communication device
1005 input device
1006 output device

1. A terminal comprising:
a receiving unit that receives, through a first component carrier of a plurality of component carriers forming carrier aggregation, scheduling information for one or more second component carriers of the plurality of component carriers; and
a control unit that configures rate matching on the one or more second component carriers, based on configuration information on the rate matching included in the scheduling information.

2. The terminal according to claim 1, wherein the configuration information on the rate matching includes information indicating whether one or more rate matching patterns configured for each component carrier of the one or more second component carriers can be used for a physical downlink shared channel (PDSCH).

3. The terminal according to claim 1, wherein the second component carriers consists of two component carriers,
wherein the configuration information on the rate matching includes information indicating whether a plurality of resource elements indicated by one or more rate matching patterns configured for one component carrier of the two component carriers can be used for a physical downlink shared channel of the one component carrier and information indicating whether a plurality of resource elements indicated by one or more rate matching patterns configured for the other component carrier of the two component carriers can be used for a PDSCH of the other component carrier.

4. The terminal according to claim 1, wherein the one or more second component carriers include the first component carrier, and
wherein the control unit configures rate matching only for the first component carrier based on the configuration information on the rate matching included in the scheduling information.

5. A communication method by a terminal, the method comprising:
receiving, through a first component carrier of a plurality of component carriers forming carrier aggregation, scheduling information for one or more second component carriers of the plurality of component carriers; and
configuring rate matching on the one or more second component carriers, based on configuration information on the rate matching included in the scheduling information.
